(19) United States
(12) Patent Application Publication
(10) Pub. No.: US 2026/0032056 A1
(43) Pub. Date: Jan. 29, 2026

(54) Method for processing a request for statistical or predictive analysis, communication method and application entities capable of implementing these methods

(71) Applicant: ORANGE, ISSY LES MOULINEAUX (FR)

(72) Inventors: Philippe Tamagnan, Chatillon (FR); Antoine Mouquet, Chatillon (FR)

(21) Appl. No.: 18/995,494

(22) PCT Filed: Aug. 4, 2023
(86) PCT No.: PCT/EP2023/071633

§ 371 Date: Jan. 16, 2025

(30) Foreign Application Priority Data
Aug. 5, 2022 (FR) FR2208145

(51) Int. Cl. H04L 41/142; H04L 41/147

(52) U.S. Cl. CPC H04L 41/142; H04L 41/147

(57) ABSTRACT

A method for processing a request for statistical or predictive analysis received by a first application entity of a communications network originating from a second application entity of the network. The method includes: determining, from at least one item of information conveyed by the request, a context in which the request was formulated by the second application entity; performing the requested statistical or predictive analysis by using an analysis model selected according to the determined context; and providing at least one result of the analysis performed in response to the request from the second application entity.

### CROSS-REFERENCE TO RELATED APPLICATIONS

This application is a Section 371 National Stage Application of International Application No. PCT/EP2023/071633, filed Aug. 4, 2023, and published as WO 2024/028472 A1 on Feb. 8, 2024, not in English, which claims priority to and the benefit of French Patent Application No. 2208145, filed Aug. 5, 2022, the contents of which are incorporated herein by reference in their entireties.

### FIELD OF THE DISCLOSURE

The invention belongs to the general field of telecommunications.

It more specifically relates to the communications networks that rely on a plurality of application entities implementing various functionalities or services in the network, such as, for example, a 5G Core network (or “5GC”) as defined by the 3GPP standard. Such application entities are, for example, devices (hardware or software) hosting Network Functions (or “NF”) implementing functionalities such as network access, the mobility of the users or even the management of the sessions established in the network, the storage and publication of the profiles of the network functions, etc.

### BACKGROUND OF THE DISCLOSURE

In order to optimize the procedures within the 5G core network, the NF functions can use a specific NF function responsible for collecting and analyzing network data, referred to as the NWDAF (“NetWork Data Analytics Function”) function. The NWDAF function offers the NF functions of the network using said NWDAF function statistical and/or predictive analyses concerning the behavior of the network, notably in terms of quality of service, and/or concerning the behavior of the user equipment (or UE). The completed analyses can be general, i.e., can be established on the network, on a server, on an application or even on a region (for example, network resource load rate at a particular time of the day or year, average quality of service, number of users connected to the network or active sessions, etc.), or can be individual, i.e., can relate to a UE or to a particular group of UEs (for example, future location of a UE, volume of a future communication session of a UE, etc.). The analyses are carried out based on raw data that the NWDAF function collects from other NF functions of the network and/or from nodes of the radio access network via the network management entity responsible for operations, administration and maintenance, also known as OAM entity (“Operations, Administration and Maintenance”), and to which the NWDAF function applies one or more analysis models as a function of the analyses it is requested to carry out. Such analysis models are, for example, statistical analysis models, such as a moving average, a movable exponential average, etc., or predictive analysis models notably using supervised or unsupervised learning technologies.

Once established, the statistical and/or predictive analyses typically allow the anticipated implementation of corrective modifications on the network parameters in order to optimize its operation. More specifically, the user entities of these analyses, in other words the client NF functions of the NWDAF function (which may or may not be distinct from the NF functions that collected and delivered the raw data to the NWDAF function), are able, as a function of the statistical and/or predictive analyses received from the NWDAF function, to adapt their behavior with a view to optimizing the operation of the network and the quality of the service delivered to each user on their UE. The client NF functions of the NWDAF function are, for example, an Access and Mobility management Function (AMF), a Session Management Function (SMF), a Policy Control Function (PCF), etc.

The 3GPP document TR 23.791, entitled, “Technical Specification Group Services and System Aspects; Study of Enablers for Network Automation for 5G (Release 16)”, V16.2.0, June 2019, mentions various use cases for such statistical and/or predictive analyses in a 5G network.

Thus, for example, mobility predictions of the UEs can be used by the AMF function to optimize the mobility management of the UEs, and in particular to determine their Registration Area (or RA), with this registration area allowing standby UEs to be located and sent paging messages when data that is intended for them reaches the network, etc. This use case is also described in the 3GPP document TS 23.501 entitled, “Technical Specification Group Services and System aspects; System architecture for the 5G system (5GS); Stage 2 (Release 17)”, V17.4.0, March 2022, notably in paragraph 5.3.2.

According to another example that is also described in the 3GPP document TS 23.501, in paragraph 6.3.3.3, it may be useful for the SMF function to have statistics or predictions available concerning the network traffic (for example, the load) when selecting a User Plane Function (“UPF”) for routing the data of the PDU (“Packet Data Unit”) sessions.

According to another example that is also notably described in the 3GPP document TS 23.503 entitled, “Technical Specification Group Services and System aspects; Policy and charging control framework for the 5G system (5GS); Stage 2 (Release 17)”, V17.4.0, March 2022, notably in paragraphs 4.2.3 and 6.1.1.3, a PCF function can request statistical dispersion analyses in order to modify policies or to determine the average throughput for a slice of a network. It also should be noted that the same statistical and/or predictive analysis can be requested in order to assist various NF functions of the network in various contexts and/or in order to implement various functionalities.

It can be clearly understood, in view of the numerous use cases of statistical and/or predictive analyses delivered by the NWDAF function and their importance in the operational functioning of the network, that these analyses must be precise and relevant.

### SUMMARY

The invention notably addresses this requirement by proposing a method for processing a request for a statistical or predictive analysis received by a first application entity of a communications network originating from a second application entity of the network, said method comprising:
a step of carrying out said requested statistical or predictive analysis by means of an analysis model that is selected as a function of a formulation context for said request by said second application entity, determined based on at least one item of information conveyed by the request; and
a step of delivering at least one result of the analysis carried out in response to the request from the second application entity.

Correspondingly, the invention also relates to an application entity of a communications network, called first application entity, comprising:
a receiving module, configured to receive a request for a statistical or predictive analysis from a second application entity of the network;
a processing module, configured to carry out said analysis by means of an analysis model that is selected as a function of a formulation context for said request by said second application entity, determined based on at least one item of information conveyed by said request; and
a delivery module, configured to deliver at least one result of the analysis carried out in response to the request from the second application entity.

As mentioned above, the invention has a preferred but non-limiting application within the context of a 5G core network. Thus, for example, the first application entity and the second application entity host network functions, with the network function hosted by the first application entity being a data collection and analysis function of the network.

However, it should be noted that if the requirement for statistical and/or predictive analyses has been formulated within the context of a 5G network, the fact remains that such a requirement can arise in other situations, notably in other communication networks (for example, proprietary networks), between application entities other than an NF function and an NWDAF function, etc. An application entity is understood herein to be any type of communicating device, such as a hardware or virtual (i.e., software) device, configured to implement a determined processing logic, such as, for example, a device offering and/or consuming services in a network, such as a network function (NF) or a network function instance of a core network compliant with the 3GPP standard, but also a router management unit or even an SDN (“Software Defined Network”) controller in an IP (“Internet Protocol”) network, etc.

Thus, the invention proposes improving the quality and the precision of the statistical and predictive analyses requested by an application entity (second application entity within the meaning of the invention) from another application entity (first application entity within the meaning of the invention) by taking into account the context in which this request is formulated, i.e., the use context of the requested predictive and/or statistical analysis. Such a formulation context (or use context of the requested analysis) typically can include the reason for this request, i.e., the destination of the analysis result or the use case for which the statistical and/or predictive analysis is requested. Thus, in a particular embodiment, the formulation context identifies a procedure that is intended to be executed by the second application entity in the network using the analysis result provided by the first application entity (for example, a registration of a UE, opening of a data session, etc.).

Indeed, the inventors have found that, in a 5G core network, each procedure of the network that requests the completion of statistical and/or predictive analyses (for example, registration, opening a session, optimization of a user profile, etc.) is a specific use case where it is desirable for the NWDAF function (first application entity within the meaning of the invention) to deliver the most relevant result in order to optimize this procedure. Moreover, as mentioned above, the same statistical and/or predictive analysis can be requested by the same application entity or by distinct application entities during two different procedures, in other words, for different uses (for example, long-term requirements vs short-term requirements). However, to date, in order to carry out its requested analysis, the NWDAF function solely relies on the parameters provided in the request that strictly speaking define the requested analysis (for example, expected type of analysis and its precision level, the target of the analysis, etc.) and on the raw data that it collects from various network entities. The analysis model used by the NWDAF function can become less efficient when having to respond to a plurality of different use cases.

Knowledge of the formulation context for the request, and in particular the reason behind making this request, constitutes valuable information for the first application entity in order to improve the precision and the relevance of the statistical and/or predictive analysis that it carries out. Indeed, this information provides the first application entity the possibility of most appropriately selecting the analysis model that will deliver the best statistical and/or predictive analysis for a given application situation, in other words, for a given use case. For example, for an AMF function, knowing that an analysis is used to update a registration area or to locate a UE (also more commonly referred to as “paging”) can result in the selection of analysis models that are very different in terms of mathematical technique and/or adjustment parameters. In order to better understand the contribution of the invention, an analogy can be made with everyday life and the situation of a physician who has to carry out analyses on a patient without any available information concerning their patient (for example, their age, whether or not they are a smoker, etc.) or the reason why these analyses are necessary (for example, presence of pain).

The formulation context that is obtained therefore constitutes external assistance that guides the choices made by the first application entity in order to carry out the requested analysis and to make suitable arrangements in order to obtain a relevant result for this analysis.

Various ways can be contemplated in order to obtain the formulation context.

Thus, in a particular embodiment, the formulation context is indicated by a parameter introduced by the second application entity into a dedicated field of the request.

In other words, the formulation context is explicitly entered by the second application entity, in a specific parameter, when it formulates its request. Such a dedicated parameter is called UseCaseContext, for example. Various formats can be contemplated for this dedicated parameter, such as, for example, an integer, a character string, a list of integers or of character strings, etc. The values of the parameter may or may not be predefined.

This embodiment is particularly easy to implement and allows the first application entity to obtain reliable and precise information concerning the formulation context for the request.

As a variant, the formulation context can be determined by the first application entity based on a plurality of parameters defining the analysis requested by the second application entity and provided in the request. Such parameters are taken, for example, from among:
an identity of the second application entity;
a parameter representing a requested type of analysis (for example, the type and quantity of the obtained results, etc.);
at least one equipment on which the analysis is based;
a parameter representing a condition for carrying out the analysis (for example, geographical area, time period, relevant network slice, etc.);
an expected level of precision for the analysis;
a parameter representing a notification term of said at least one result of the analysis (for example, periodicity, subscription, etc.).

Some groups of parameters provided in the request, and the values associated with these groups of parameters, actually can be considered to be signatures representing distinct contexts. Various possibilities then can be contemplated:
the first application entity is configured with a certain number of signatures with which contexts are associated. Upon reception of the request, the first application entity determines, based on the parameters provided in the request, if they correspond to one of the signatures it has available. If applicable, the formulation context for the request is that which is associated with the signature;
the first application entity implements a learning phase, during which it analyzes the parameters present in the received requests and determines, for example, by means of a classification algorithm, which groups of parameters and associated values are significant and represent a particular context. The various groups of parameters and associated values thus obtained define a set of signatures corresponding to distinct formulation contexts. It should be noted that, in this case, the first application entity is able to distinguish it from distinct formulation contexts, and to associate a given formulation context with a request, but it does not necessarily have the necessary information for associating a specific operation with this formulation context that is executed or is intended to be executed by the second application entity (for example, determining a registration area).

It also should be noted that some of the parameters provided in the request may exhibit a certain amount of variability for a given use case; it is also worthwhile properly selecting the parameters that allow the first application entity to deduce the formulation context for the request as a function of the various use cases.

In another alternative embodiment, it is possible to contemplate that the formulation context entered by the second application entity in a specific field of the request is refined by the first application entity by exploiting the parameters conveyed by the request defining the analysis requested by the second application entity. The formulation context determined by the first application entity then comprises the context entered by the second application entity (for example, the procedure in which the request is formulated and the analysis result will be exploited) optionally supplemented by other information originating from the parameters for defining the analysis (for example, UE or a group of UEs or a cell, etc.).

As mentioned above, according to the invention, the formulation context for the request is used by the first application entity to select a relevant analysis model for carrying out the requested statistical and/or predictive analysis.

The analysis model can be selected in various ways. Thus, it can comprise, for example, selecting at least one element from among:
a statistical or predictive analysis technique to be used to carry out the analysis;
at least one feature of a dataset to be used for carrying out the analysis and/or training an analysis technique used to carry out the analysis;
configuring an analysis technique used to carry out the analysis; etc.

Adjusting all or some of the aforementioned elements allows the first application entity to obtain analysis results that are highly relevant for the second application entity, which allows said second application entity to optimize the procedures that it implements within the context of its assigned functions in the network.

Various courses of action can be contemplated in order to allow the first application entity to select an analysis model that is adapted to the formulation context for the request.

Thus, in a particular embodiment, the processing method comprises a preliminary step of configuring the first application entity with a list of analysis models in which each analysis model is associated with at least one formulation context for a request, with the analysis model applied during the step of carrying out an analysis being an analysis model that in this list is associated with the context determined during the acquisition step.

This embodiment involves pre-configuring the first application entity, for example, by the network operator, with a list of possible models adapted to various contexts. It is relatively simple to implement. It should be noted that the list thus pre-configured can be updated at any time via an appropriate configuration message sent to the first application entity.

In another embodiment, the processing method comprises a learning step, during which the first application entity:
establishes correlations between analysis models, formulation contexts for a request, and quality indicators of the analyses carried out based on said models in said contexts; and
associates, based on the established correlations, an analysis model optimizing said quality with at least one formulation context for a request;
   with the analysis model applied during the step of carrying out the analysis being selected based on the associations established during the learning step.

This embodiment is preferably applicable when the first application entity does not have a pre-configuration for a given formulation context, or, in general, does not have any pre-configuration. In this embodiment, it is the first application entity that, by learning, optimizes the selection of an analysis model as a function of the formulation context for the analysis request addressed thereto. Advantageously, this embodiment is scalable and allows the first application entity to take into account the quality of the analysis results that it obtains in order to optimize the choice of the analysis models.

In yet another embodiment, the processing method comprises:
a preliminary step of configuring the first application entity with a list comprising at least one analysis model associated with at least one formulation context for a request;
a learning step, during which the first application entity:
   establishes correlations between analysis models, formulation contexts for a request, and quality indicators of the statistical analyses carried out based on said models in said contexts; and
   updates and/or supplements said list based on said established correlations;
      with the analysis model applied during the step of carrying out the analysis being an analysis model associated with the context determined during the acquisition step in the list updated or supplemented during the learning step.

This embodiment advantageously combines the two preceding embodiments, and thus benefits from the advantages associated with each of them.

In light of the above, the invention relies on the first application entity, which obtains a formulation context for the analysis request addressed thereto and exploits this context in order to optimize the analysis results that it delivers in response to this request, but also, in a particular embodiment, it relies on the second application entity that is the source of the request and that provides the first application entity with said formulation context.

Thus, according to another aspect, the invention relates to a method for communicating with a first application entity of a communications network, with this communication method being implemented by a second application entity of the network and comprising:
a step of sending the first application entity a request for a statistical or predictive analysis comprising, in a dedicated field of the request, a parameter indicating a formulation context for the request; and
a step of receiving, in response to the request, at least one result of the requested analysis carried out by the first application entity by means of an analysis model that is selected as a function of this context.

Correspondingly, a further aim of the invention is an application entity of a communications network, called second application entity, comprising:
a sending module, configured to send a first application entity of the network a request for a statistical or predictive analysis comprising, in a dedicated field of the request, a parameter indicating a formulation context for the request; and
a receiving module, configured to receive, in response to said request, at least one result of the requested analysis carried out by the first application entity by means of an analysis model that is selected as a function of this context.

According to yet another aspect, the invention also relates to a system in a communications network comprising at least one first application entity and at least one second application entity according to the invention.

The communication method, the second application entity and the system according to the invention benefit from the same aforementioned advantages as the processing method and the first application entity.

In a particular embodiment, the processing and communication methods are implemented by a computer.

A further aim of the invention is a computer program on a storage medium, with this program being able to be implemented in a computer or more generally in a first application entity according to the invention and comprising instructions adapted for implementing a processing method as described above.

A further aim of the invention is a computer program on a storage medium, with this program being able to be implemented in a computer or more generally in a second application entity according to the invention and comprising instructions adapted for implementing a communication method as described above.

Each of these programs can use any programming language, and can be in the form of source code, object code, or of intermediate code between source code and object code, such as in a partially compiled format, or in any other desirable format.

A further aim of the invention is an information medium or a computer-readable storage medium, and comprising instructions of a computer program as mentioned above.

The information or storage medium can be any entity or device capable of storing the programs. For example, the medium can comprise a storage means, such as a ROM, for example, a CD-ROM or a microelectronic circuit ROM, or even a magnetic storage means, for example, a hard disk, or a flash memory.

Moreover, the information or storage medium can be a transmissible medium such as an electrical or optical signal, which can be routed via an electrical or optical cable, via a radio link, via a wireless optical link or via other means.

The program according to the invention particularly can be downloaded over a network of the Internet type.

Alternatively, the information or storage medium can be an integrated circuit, in which a program is incorporated, with the circuit being adapted to execute or to be used to execute the management, registration and communication methods according to the invention.

It is also possible to contemplate, in other embodiments, that the processing and communication methods, the first and second application entities and the system according to the invention in combination have all or some of the aforementioned features.

### BRIEF DESCRIPTION OF THE DRAWINGS

Further features and advantages of the present invention will become apparent from the following description, with reference to the appended drawings, which illustrate an embodiment that is by no means limiting. In the figures:

FIG. 1 shows, in its environment, a system in a network according to the invention, in a particular embodiment;

FIG. 2 schematically shows the hardware architecture of a computer capable of hosting any one of the entities according to the invention belonging to the system of FIG. 1;

FIG. 3 shows the functional modules of the application entities according to the invention of the system of FIG. 1;

FIG. 4 shows the main steps of a processing method according to the invention as they are implemented by a first application entity of the system of FIG. 1;

FIG. 5 shows the main steps of a communication method according to the invention as they are implemented by a second application entity of the system of FIG. 1.

### DESCRIPTION OF THE INVENTION

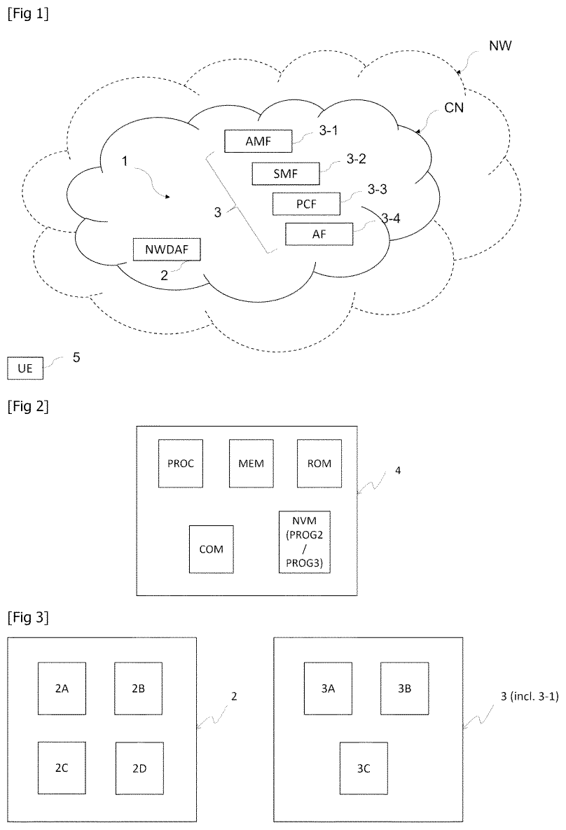

FIG. 1 shows, in its environment, a system 1 in a communications network CN, according to the invention, in a particular embodiment.

In the example contemplated in FIG. 1, the network CN is a 5GC core network of a 5G communications network NW as defined by the 3GPP standard, relying on a plurality of application entities hosting network functions (or NF functions) implementing various functionalities or services in the core network, such as network access, the mobility of the users or even the management of the sessions established in the network, the storage and publication of the profiles of the network functions, etc.

As mentioned above, in order to optimize the procedures within the core network CN, the NF functions can use a specific NF function responsible for collecting and analyzing network data, referred to as the NWDAF (“NetWork Data Analytics Function”) function. This NWDAF function offers the NF functions of the network using said NWDAF function statistical and/or predictive analyses concerning the behavior of the network CN, or, more generally, of the network NW, notably in terms of quality of service, and/or concerning the behavior of the UEs of the network NW. These analyses can be general (for example, established on the network, a server, an application or even a region), or can be individual (i.e., relate to a UE or to a particular group of UEs). They are carried out based on raw data collected by the NWDAF function and statistical and/or predictive analysis models applied to this raw data.

According to the invention, the system 1 comprises:
at least one first application entity 2, according to the invention. In the embodiment described herein, the application entity 2 hosts an NWDAF network function for collecting and analyzing data of the network NW as described above, and throughout the remainder of the description is designated NWDAF entity 2; and
at least one second application entity 3, according to the invention, configured to consume the services offered by the NWDAF entity 2, in other words, paging the NWDAF entity 2 in order to obtain statistical and/or predictive analyses concerning the behavior of the network and/or of a UE or of a group of UEs. In the embodiment described herein, the one or more application entities 3 also host NF functions of the core network CN. There is no limit associated with the NF functions hosted by the application entities 3. Thus, in the example shown in FIG. 1, the system 1 comprises a plurality of application entities 3 according to the invention, notably including an application entity 3-1 hosting an AMF network access function (also designated AMF entity 3-1 hereafter), an application entity 3-2 hosting an SMF session management function (or SMF entity 3-2), an application entity 3-3 hosting a PCF policy control function (or PCF entity 3-3), and an application entity 3-4 hosting an AF application function (or AF entity 3-4). This list is not limiting and is provided solely by way of an illustration.

Each application entity of the system 1 is a communicating, hardware or virtual (i.e., software), device configured to implement a determined processing logic, corresponding to the network function that it hosts. Thus, the invention equally applies to software or virtual application entities and to hardware application entities hosting network functions.

When the considered application entities are hardware devices (for example, servers of an infrastructure of the core network CN), they then assume the hardware architecture of a computer 4, as illustrated in FIG. 2. This hardware architecture relies on a processor PROC, a random-access memory MEM, a read-only memory ROM, a non-volatile memory NVM, and means COM for communicating with other entities, for example, other application entities of the core network CN, entities of an access network to the core network CN, such as, for example, an OAM entity for managing the network NW (not shown in FIG. 1), or even with UEs of the network NW. These communication means COM can notably rely on a wired or wireless communication interface, per se known and not described in further detail herein, but also on one or more software interfaces, such as an application programming interface (API) or a point-to-point communication interface.

When the considered application entities are software, they are themselves hosted by a hardware device assuming the hardware architecture of the computer 4, and can then rely on the aforementioned hardware means of the computer 4 (PROC, MEM, ROM, NVM, COM). Throughout the remainder of the description, for the sake of simplification, reference will be equally made to the means PROC, MEM, ROM, NVM, COM of the considered application entity, whether said entity is hardware or software.

The non-volatile memory NVM of the computer 4 constitutes a storage medium according to the invention, which can be read by the processor PROC and which stores a computer program according to the invention. In the case of an application entity 2, this computer program is referenced PROG2 and comprises instructions defining the main steps of a processing method according to the invention. For an application entity 3, the computer program in question is referenced PROG3 and comprises instructions defining the main steps of a communication method according to the invention.

The program PROG2 defines the functional modules of an application entity 2, and notably of the NWDAF entity 2 of the system 1, that rely on or control the aforementioned elements PROC, MEM, ROM, NVM, and COM of the computer 4. These functional modules notably include, in the embodiment described herein, as illustrated in FIG. 3:
a receiving module 2A, configured to receive a request REQ for a statistical or predictive analysis from an application entity 3 of the system 1;
a determination module 2B, configured to obtain a formulation context CTX for the request by the application entity 3 from at least one item of information conveyed by this request REQ. Such a formulation context CTX typically represents the use case of the requested statistical or predictive analysis, it identifies, for example, a procedure that the application entity 3 will execute using the result of the requested statistical or predictive analysis;
a processing module 2C, configured to carry out the requested analysis by means of an analysis model that is selected as a function of the context CTX determined by the determination module 2B; and
a delivery module 2D, configured to provide at least one result of the analysis carried out by the processing module 2C in response to the request REQ from the application entity 3.

The configuration and the operation of the modules 2A to 2D of the application entity 2, and more specifically of the NWDAF entity 2, are described in further detail hereafter with reference to the steps of the processing method according to the invention.

Similarly, the program PROG3 defines the functional modules of an application entity 3, and more specifically of each of the entities AMF 3-1, SMF 3-2, PCF 3-3 and AF 3-4 of the system 1, with these functional modules relying on or controlling the aforementioned elements PROC, MEM, ROM, NVM, and COM of the computer 4. In the embodiment described herein, the functional modules of an application entity 3 according to the invention notably comprise, as illustrated in FIG. 3:
a sending module 3A, configured to send the application entity 2, and more specifically in this case the NWDAF entity 2, a request REQ for a statistical or predictive analysis. In the embodiment described herein, the sending module 3A is configured to use an API of the NWDAF entity 2, in order to send the request REQ, as described in further detail hereafter. It is also configured to introduce, in a dedicated field of the request, called UseCaseContext by way of an illustration, a parameter into the request REQ indicating the formulation context CTX for the request, in other words, the use context of the one or more results of the requested analysis;
a receiving module 3B, configured to receive, in response to the request REQ addressed to the NWDAF entity 2, at least one result of the requested analysis carried out by the NWDAF entity 2 by means of an analysis model selected by said entity as a function of the context CTX; and
an execution module 3C, configured to execute a procedure associated with the network function hosted by the application entity 3 using an analysis result received by the receiving module 3B. Of course, the executed procedure depends on the network function hosted by the application entity 3. It can be, for example, a procedure for registering or determining a registration area for the AMF entity 3-1, a procedure for opening a session or for selecting a UPF function of the user plane of the core network CN for the SMF entity 3-2, a procedure for modifying a policy or for determining an average throughput for a given network slice for a PCF entity 3-3, a procedure for optimizing an adjustment for a UE or for detecting fraud for an AF entity 3-4, etc.

The configuration and the operation of the modules 3A to 3C of the application entities 3 are described in further detail hereafter with reference to the steps of the communication method according to the invention.

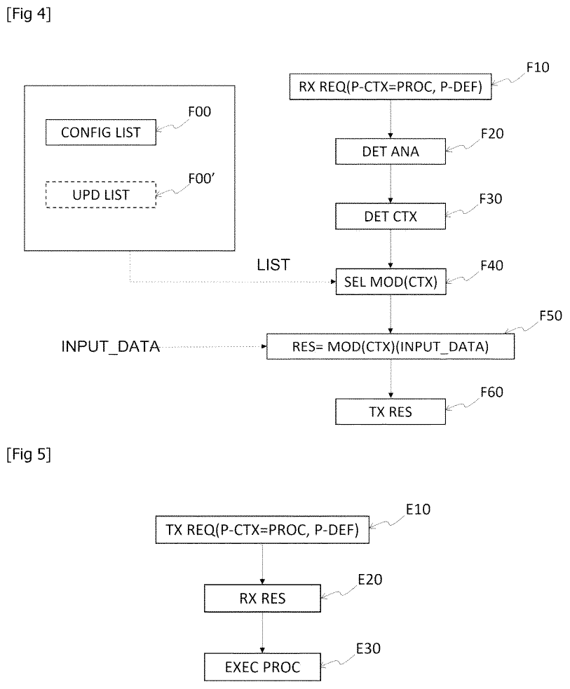

The main steps of a processing method and of a communication method according to the invention will now be described, with reference to FIGS. 4 and 5, respectively, as implemented in a particular embodiment by the NWDAF entity 2 and by one of the application entities 3 of the system 1. More specifically, the AMF entity 3-1 is considered in this case by way of an illustration; however, the steps of the communication method are implemented in a similar or identical manner by any other application entity 3 of the system 1.

It is therefore assumed in this case that the AMF entity 3-1 needs statistical and/or predictive analyses in order to execute one of the procedures PROC for which it is responsible in the core network CN. More specifically, in the illustrative example contemplated in this case, it is assumed that the AMF entity 3-1 needs a prediction of the mobility of a given UE, for example, of the UE 5 shown in FIG. 1, with a view to determining a registration area for this UE 5 (procedure PROC=determination of the registration area of the UE 5).

Of course, these assumptions are not limiting per se and are only set forth by way of an illustration. Other procedures can be implemented by the AMF entity 3-1 within the context of the network function implemented by this entity, and require or rely on statistical and/or predictive analyses of the NWDAF entity 2, which can also relate to types of analysis other than a prediction of mobility of a UE, such as, for example, a prediction concerning the nature of the communications of a UE, etc.). Thus, the aforementioned 3GPP document TR 23.791 cites various use cases of statistical and/or predictive analyses carried out by an NWDAF network function in a 5G network.

With reference to FIG. 5, the AMF entity 3-1 sends a request REQ to the NWDAF entity 2 via its sending module 3A, and more specifically to its receiving module 2A, requesting a prediction of the mobility of the UE 5 (step E10).

In the embodiment described herein, the sending module 3A of the AMF entity 3-1 uses the Nnwdaf_AnalyticsInfo service of the API of the NWDAF entity 2 to this end, as described in 3GPP documents TS 23.288 entitled, “Architecture Enhancements for 5G system (5GS) to support network data analytics services (Release 17)”, V17.4.0, March 2022, and TS 29.520 entitled, “Technical Specification Group Core Network and Terminals; 5G System; Network Data Analytics Services; Stage 3; (Release 17)”, V17.6.0, March 2022. The request REQ in this case is a simple request of the Nnwdaf_AnalyticsInfo Request type. As a variant, it can assume the form of a subscription (Nnwdaf_AnalyticsSubscription service and Nnwdaf_AnalyticsSubscription Subscribe subscription), as described in 3GPP documents TS 23.288 and TS 29.520. It also should be noted that sending the request REQ by the sending module 3A, although it is linked to a procedure implemented by the AMF entity 3-1 (and more specifically executed or intended to be executed by its execution module 3C), is not necessarily synchronously carried out with this procedure. It can be carried out asynchronously, typically upstream of the procedure in question, in an anticipated manner, in order to be able to have the result of the analysis so as to execute the relevant procedure without delay.

As defined by the 3GPP standard, the sending module 3A of the AMF entity 3-1 delivers various parameters P-DEF in the request REQ defining the requested statistical and/or predictive analysis, and notably:
the identity of the application entity that is the source of the request, i.e., in this case the identity of the AMF entity 3-1;
one or more parameters representing the requested type of analysis. This parameter or these parameters can notably define the nature of the analysis or, equivalently, the type of result that is expected (for example, prediction of mobility in this case), the amount of expected results, etc.;
the target of the analysis, i.e., the equipment the analysis relates to (for example, the UE 5 in this case);
one or more parameters representing conditions for carrying out the analysis, for example, the targeted time period, the targeted geographical area, the relevant network slice, etc.;
an expected level of precision for the analysis;
one or more parameters representing the notification terms of the analysis network (for example, periodicity, subscription, etc.).

Of course, this list is not exhaustive, and a person skilled in the art is invited to refer to the aforementioned 3GPP documents TS 23.288 and TS 29.520 in order to obtain the list of compulsory, and, if applicable, optional, parameters P-DEF that must or can be included by the sending module 3A in the request REQ addressed to the NWDAF entity 2.

According to the invention, the sending module 3A of the AMF entity 3-1 also introduces, in a dedicated field and more specifically in the previously introduced UseCaseContext field, a parameter P-CTX into the request REQ indicating the context CTX in which the request REQ is formulated, i.e., the use context of the one or more results of the analysis requested in the request REQ. The parameter P-CTX in this case identifies the procedure PROC that the AMF entity 3-1 is about to execute by using the result of the prediction requested in the request REQ. Thus, in the contemplated illustrative example, the parameter P-CTX contained in the UseCaseContext field of the request REQ identifies the determination of the registration area of the UE 5 as the procedure.

Thus, in the embodiment described herein, a new UseCaseContent field is added to the exchanged messages using the Nnwdaf_AnalyticsInfo and Nnwdaf_AnalyticsSubscription services.

There is no limit associated with the format of the parameter P-CTX. It can be an integer unequivocally designating the context CTX, a string of characters defining this context CTX, or even a list of integers or character strings, etc. Furthermore, it is possible to contemplate the parameter in question assuming a predefined value from among a set of predefined values, each unequivocally associated with a particular context (for example, 1=“registration of a UE by an AMF function”, 2=“determination of a registration area of a UE by an AMF function”, etc.), or, on the contrary, assuming any value as long as the NWDAF entity 2 is capable of associating this value with a particular context (there must be no ambiguity for the NWDAF entity 2 in order to identify which context is designated from the value in question, in other words, the same value must not identify different formulation contexts).

Appendix 1 provides, by way of an illustration, a non-exhaustive list established by the inventors of associated predictive or statistical contexts and analyses likely to be requested from an NWDAF function in a 5G network, and, therefore, incidentally in the network CN. In the examples provided in Appendix 1, the same context CTX can be associated with various statistical/predictive analyses: for example, the context of “Modification of RFSP policies by a PCF” can rely on analyses relating to the load of network slices or on analyses relating to the UE communications and the Observed Service Experience (or OSE). The corresponding requests that in this example are addressed by the PCF entity to the NWDAF entity include the same parameter P-CTX designating the context of “Modification of RFSP policies by a PCF”, while the parameters P-DEF provided in the requests designate, for one of the requests, a statistical/predictive analysis relating to the load of the network slices, and for the other request, statistical/predictive analyses relating to the UE communications and to the OSE.

However, it is possible to associate a different context with the same operation of a PCF modifying RFSP policies as long as it is carried out for a specific purpose, for example, for preserving the quality of a vehicle communication service, known as V2X (“Vehicle-to-everything”). It also should be noted that the X in V2X can designate all kinds of entities, such as, for example, another vehicle, a drone, an infrastructure, a pedestrian, etc., such that a different context can be associated with each different X contemplated for the V2X service, with the considered type of entity X being able to influence the choice of the analysis model.

In an alternative embodiment, it is possible to contemplate including the statistical/predictive analyses in the context information that, if applicable, the operation designated by the context or, more generally, the use case of these analyses relies on. Thus, by way of an illustration, in the aforementioned example, a first “Modification of RFSP policies by a PCF based on a statistical/predictive analysis of the load of network slices” context can be contemplated and a second “Modification of RFSP policies by a PCF based on statistical/predictive analyses of UE and OSE communications” context can be contemplated. It should be noted that this precision provided in the context does not necessarily imply a change in the content of the parameters P-DEF provided in the request. Indeed, in order to limit the impact of the invention on existing messages already defined by the 3GPP standard (in other words, in order to limit the modifications to be made to these messages), it is possible to contemplate specifying, both in the context and in the parameters P-DEF, the statistical/predictive analyses that the operation implemented by the application entity that is the source of the request relies on and that are requested from the NWDAF entity.

It should be noted that when the sending module 3A of the AMF entity 3-1 determines the formulation context CTX for the request REQ this does not raise any issues per se since it reflects the procedure PROC currently being executed by the AMF entity 3-1 (and more specifically by its processing module 3C) or a procedure PROC that this AMF entity 3-1 is about to execute (with the request REQ not necessarily being synchronously sent with respect to the execution of the procedure in question).

With reference to FIG. 4, upon reception of the request REQ by its receiving module 2A (step F10), the NWDAF entity 2 determines, by means of its processing module 2C and based on the parameters P-DEF provided in the request REQ, the statistical and/or predictive analysis that the AMF entity 3-1 requested (step F20), namely, in the illustrative example contemplated in this case, a prediction of the mobility of the UE 5 under the conditions established by the parameters P-DEF.

The NWDAF entity 2 also determines, by means of its determination module 2B and based on at least one item of information conveyed by the request REQ, the context CTX in which the request REQ has been formulated (step F30). This formulation context CTX for the request REQ provides the NWDAF entity 2 an indication as to how the prediction requested by the AMF entity 3-1 will be used.

To this end, in the embodiment described herein, the determination module 2B extracts the parameter P-CTX contained in the UseCaseContext field of the request REQ that identifies the procedure PROC paging the statistical or predictive analysis requested in the request REQ.

It should be noted that in the embodiment described herein, the request REQ includes the UseCaseContext field, and this field is supplied by the AMF entity 3-1 with the parameter P-CTX identifying the context in which the request REQ is formulated. Thus, the determination module 2B determines the context CTX based on the content of the parameter P-CTX included in the UseCaseContext field of the request REQ. As a variant, it is possible to contemplate that the UseCaseContext field is optional, and that without such a field in the request the determination module 2B is configured to determine the formulation context CTX for the request REQ based on the information conveyed thereby, and notably based on all or some of the aforementioned parameters P-DEF, namely, the parameters P-DEF provided by the AMF entity 3-1 in the request REQ representing its identity, the requested type of analysis, the target of this analysis (for example, a UE or a group of UEs, a cell, etc.), the conditions for carrying out this analysis, the expected level of precision, the terms for notifying the results of the analysis, etc. To this end, the determination module 2B can rely on a supervised or unsupervised artificial intelligence (or AI) technique, or can be configured with preset rules, which are defined, for example, by the operator of the core network CN, establishing a match between the values of all or some of the aforementioned parameters P-DEF conveyed by the request REQ and various formulation contexts for this request REQ.

In yet another variant, it is possible to contemplate a hybrid mode in which the determination module 2B determines the context based on the content of the parameter P-CTX included in the UseCaseContext field and the other information conveyed by the request REQ, typically the parameters P-DEF. This hybrid mode allows a more precise context to be obtained (and a finer granularity in the choice of the analysis model).

For example, some groups of parameters P-DEF provided in the request REQ and the values associated with these groups of parameters can be used to define signatures representing distinct contexts.

It is then possible to contemplate, according to an alternative embodiment, that the NWDAF entity 2, and more specifically its determination module 2B, is configured with a certain number of signatures associated with contexts, and that upon reception of the request REQ, the determination module 2B determines, based on the parameters P-DEF provided in the request REQ, if they correspond to one of the signatures with which it has been configured. If applicable, the formulation context for the request determined by the determination module 2B is that which is associated with the signature.

The configuration of the NWDAF entity 2 notably can be carried out by the operator of the network CN by means of signatures determined by them, for example, during a configuration phase as is conventionally implemented when introducing new equipment or services into a network.

According to another alternative embodiment, the determination module 2B of the NWDAF entity 2 can implement a learning phase, during which it analyzes the parameters P-DEF present in a set of requests REQ previously received by the NWDAF entity 2, and determines, for example, by means of a classification algorithm, which groups of parameters and associated values are significant and represent a particular context. The various groups of parameters and associated values thus obtained define a set of signatures corresponding to distinct formulation contexts.

It should be noted that in this alternative embodiment, the determination module 2B is able to distinguish between distinct formulation contexts, and to associate a given formulation context with a request; however, it does not necessarily have information that is needed in order to associate a specific operation with this formulation context that is executed or intended to be executed by the application entity that is the source of the request REQ (for example, determination of a registration area). By way of an illustration, assuming that the parameters P-DEF include three parameters X, Y, Z, and that during the learning phase the determination module 2B determines that:
if X=0 and Y=1, irrespective of the value of the parameter Z, then this is always within a context whereby the determination module 2B associates a tag CTX1; and
if X=1 and Y=1, irrespective of the value of the parameter Z, then this is always within a different context whereby the determination module 2B assigns the tag CTX2.

Upon reception of a new request REQ, the determination module 2B is capable, based on these signatures, of determining whether the formulation context for the new request REQ is the context CTX1 or the context CTX2, but without additional information it is not capable of identifying the procedure associated with the context thus determined, i.e., for example, that CTX1 identifies a procedure for determining a registration area and CTX2 identifies a procedure for optimizing paging.

In order to overcome this, in yet another variant, it is possible to contemplate the determination module 2B being configured, for example, by the operator of the network CN, with rules for matching the tags determined during the learning phase by the determination module 2B and procedures capable of being implemented by the application entities corresponding to these tags. In other words, in the illustrative example contemplated above, the determination module 2B is configured with the following associations:

$$CTX 1 = Determination of a registration area of a UE$$

$$CTX 2 = Optimization of paging$$

Irrespective of the variant that is adopted, it should be noted that the group of signatures on which the determination module 2B relies can change over time; notably, it can be supplemented with new signatures, or these can be modified when new learning phases are carried out.

According to the invention, the NWDAF entity 2 exploits (i.e., uses) the formulation context CTX for the request REQ to select a relevant analysis model for carrying out the analysis requested by the AMF entity 3-1, and more specifically in this case, a prediction of the mobility of the UE 5 (step F40).

Indeed, in a manner per se known, in order to carry out the requested statistical and/or predictive analyses an NWDAF network function (and a fortiori the NWDAF entity 2 and its processing module 2C) has a plurality of analysis techniques available that it can use as a function of the nature of the requested analyses. For example, for a statistical analysis relating to past behaviors, models that are conventionally used by an NWDAF network function notably are:
a model generating a moving average over all or some of the data collected by the NWDAF network function;
a model generating an exponential moving average over all or some of the data collected by the NWDAF network function;
etc.

For a predictive analysis relating to future behaviors, the prediction models conventionally used by an NWDAF network function notably rely on techniques for modeling time series using supervised or unsupervised machine learning techniques that can exploit highly varied algorithms, such as Markov chains, neural networks (for example, LSTM (Long Short Term Memory) type neural networks), exponential smoothing, ARCH (AutoRegressive Conditional Heteroskedasticity) type models, or of the ARMA or ARIMA type, which combine autoregressive (AR), moving average (MA) and optionally integrated (I) processes, etc.

Furthermore, each of the aforementioned analysis techniques can be configured in a different manner, or can rely on data sets with distinct features (in addition to the nature of the collected data, such as the amount of data, etc.) for the analysis or for the training of said analysis technique, which leads to as many distinct models that can be selected by the NWDAF entity 2. The context CTX provides the latter with a guide that allows it to make an informed and relevant selection of the analysis model to be applied in order to respond to the request of the AMF entity 3-1, and more specifically of at least one element from among:
a statistical or predictive analysis technique to be used to carry out the analysis from among a plurality of predefined techniques, such as, for example, an ARIMA model, an ARCH model, exponential smoothing, a moving average, etc. The selection can be made, for example, from among various families of known models, such as those cited above or combinations of such models; and/or
at least one feature (for example, an amount of data) of a dataset to be used for carrying out the analysis and/or training an analysis technique used to carry out the analysis; and/or
a configuration (for example, in a neural network, number of layers, neurons by layers, synaptic weights, etc.) of an analysis technique used to carry out the analysis. It should be noted that such a configuration is not limited to taking into account the input parameters provided by the AMF entity 3-1 that is the source of the request REQ.

In the embodiment described herein, the processing module 2C is allowed to select an analysis model as a function of the context CTX(determined by the determination module 2B via a prior (pre-)configuration of the NWDAF entity 2. More specifically, it is assumed that the NWDAF entity 2 has been configured during a preliminary configuration step (step F00), for example, by the operator of the network NW via an appropriate interface or the use of an appropriate configuration protocol, with a list LIST of statistical and predictive analysis models, in which list each analysis model is associated with at least one formulation context for a request. This list LIST is stored in the non-volatile memory NVM of the NWDAF entity 2, for example. It should be noted that a formulation context can be associated with several analysis models or with a family of analysis models.

By way of an illustration, for the contexts for defining a registration area of a UE and for optimizing the aforementioned paging, the following associations can be contemplated in the list LIST:

TABLE 1

| Context CTX | Analysis model(s) MOD(CTX) |
|---|---|
| Determining the registration area of a | LSTM type neural network |
| UE | |
| Optimization of paging | Markov chain |

Of course, this example is provided solely by way of an illustration and by no means limits the invention, with other contexts, analysis models and associations possibly being contemplated as a variant or in addition.

Thus, during the selection step F40, the processing module 2C of the NWDAF entity 2 consults the list LIST preconfigured in step F00, and selects an analysis model MOD(CTX) from the list LIST that is associated with the context CTX. If several analysis models are possible, the processing module 2C selects one, for example, taking into account criteria such as the computation time or the computing power necessary for all or some of the parameters P-DEF provided in the request REQ (for example, the level of precision and/or the time for providing the analysis results).

It should be noted that the list LIST stored in the non-volatile memory NVM of the NWDAF entity 2 is not necessarily set, and can change over time (step F00′).

Thus, the list LIST can be updated and/or supplemented in order to reflect this change in a similar or identical manner to the description previously provided for step F00.

As a variant, it can be updated by the NWDAF entity 2 itself, for example, by its processing module 2C, during a learning or training phase, during which the processing module 2C may need to revise the associations included in the list LIST between analysis models and formulation contexts, and/or to create new associations relating to new analysis models and/or new formulation contexts. These new analysis models and/or formulation contexts can be sent to the NWDAF entity 2 by the network operator or by another collaborator, for example, the designer of the NWDAF entity 2, or also can be determined by learning. This learning phase can rely on the analyses previously carried out by the processing module 2C for its learning data. In addition, or as a variant, it can use learning data provided by a third party, such as, for example, the network operator, the designer of the NWDAF entity 2, etc.

More specifically, for all or some of the analyses carried out by the processing module 2C, said module can assess the quality of the obtained results using determined quality indicators. To this end, the processing module 2C can, for example, after obtaining an analysis result such as a prediction, continue to collect data and check that the obtained prediction is correct, or can re-assess a new prediction based on this new data and compare the re-assessed prediction with the initial prediction. Of course, other techniques can be contemplated for assessing the quality of the results obtained by the processing module 2C.

During the learning phase, the processing module 2C correlates the statistical analysis models it has available, the various possible values of formulation contexts, and the quality indicators of the analyses carried out based on these analysis models for these formulation contexts. It then selects, for a given formulation context, the one or more analysis models resulting in the best quality indicators. It then updates the list LIST with the (new) context-analysis model associations thus obtained, if applicable (in other words, it updates/corrects some associations of the list LIST and/or supplements the list LIST with new associations obtained during the learning phase). It should be noted that the processing module 2C can execute several learning phases at different times as a function of the learning data it has available; thus, notably, during a learning phase it can target the learning data that it uses by only retaining the learning data associated with a particular formulation context, in order to determine the one or more most relevant analysis models for this context, and can change this formulation context from one learning phase to another.

In another embodiment, no preconfiguration of the NWDAF entity 2 is implemented, and it is the NWDAF entity 2 that establishes the list LIST itself via its processing module 2C and updates it over time during at least one learning (or training) phase identical or similar to that described above. This learning phrase may be supervised or unsupervised (i.e., may rely on training data provided by the network operator and/or the designer of the NWDAF entity 2 or only on learning data collected by the NWDAF entity 2).

At the same time as this selection, or equally before or after this selection, the processing module 2C collects the network data INPUT_DATA that is necessary for carrying out its requested statistical and/or predictive analysis. This collection can be carried out from different entities, as a function of the type of requested analysis, using the procedures that are notably described in 3GPP document TS 23.288, in paragraph 6.7.2.4. Once the data INPUT_DATA is collected, the processing module 2C carries out the statistical and/or predictive analysis (mobility prediction of the UE 5 in the example contemplated in this case) that has been requested by the AMF entity 3.1 by applying the analysis model MOD(CTX) to the collected INPUT_DATA data (step F50).

It should be noted that, for the sake of simplification, the function of the processing module 2C as a whole has been considered herein, without prejudice to how the processing module 2C is organized, strictly speaking, in order to provide this function. In accordance with Releases 17 and following of the 3GPP standard, the NWDAF entity in a 5G core network can be divided into two functions or modules, namely, an MLTF (Model Training Logical Function) module responsible for training and supplying the analysis models and an AnLF (Analytics Logical Function) module responsible for producing the analyses using the models provided by the MLTF module. The analysis models are obtained by the AnLF module using Nnwdaf_MLModelProvision and Nnwdaf_MLModelInfo services defined by the 3GPP standard. If such organization is contemplated for the NWDAF entity 2, then a new UseCaseContent field can be added to the Nnwdaf_MLModelProvision and Nnwdaf_MLModelInfo services, in the same way as before for the Nnwdaf_AnalyticsInfo and Nnwdaf_AnalyticsSubscription services, so that the AnLF module can specify the formulation context CTX for the request REQ for the MLTF module and so that the MLTF module selects the analysis model to be applied as a function of this formulation context CTX. In an alternative embodiment, the AnLF module itself selects the analysis model to be used as a function of the context CTX and then requests the selected model from the MTLF module.

The NWDAF entity 2 then delivers, by means of its supply module 2D, the analysis result RES obtained by the processing module 2C (prediction of the mobility of the UE 5 in the example contemplated in this case) to the AMF entity 3-1 in response to its request REQ (step F60).

Once the receiving module 3B of the AMF-1 entity (step E20) receives the response from the NWDAF entity 2 containing the analysis result RES, the execution module 2C of the AMF entity 3-1 executes the procedure PROC in which it paged the NWDAF entity 2 by using the analysis result RES provided by the NWDAF entity 2 (step E30). Thus, in the illustrative example contemplated in this case, the execution module 3C determines the registration area of the UE 5 using the mobility prediction of the UE 5 provided by the NWDAF entity 2, in a manner per se known.

The invention has been described above within the context of a 5G core network, and notably of an NWDAF function of such a network, by advantageously relying on the APIs defined by the 3GPP standard, modified for the purposes of the invention. However, the invention can be applied in other contexts, and notably to other networks, for example, to proprietary networks, networks of future generations or corresponding to other versions (or “releases”) of a 5G network, IP networks, etc., to other application entities, such as, for example, routers, SDN controllers, etc., which can be paged by various application entities of the network with a view to delivering statistical and/or predictive analyses, and can use interfaces other than APIs (for example, point-to-point interfaces) to implement the invention.

### APPENDIX 1

| | TYPE(S) OF REQUESTED STATISTICAL OR |
|---|---|
| CONTEXT CTX | PREDICTIVE ANALYSES |
| Selection of an SMF by an AMF or an SCP | SMF load |
| (“Service Communication Proxy”) | |
| Selection and reselection of a UPF by an SMF | UPF load |
| Selection/modification by an AMF or NSSF (“Network | Network slices load |
| Slide Selection Function”) of a network slice | |
| Modification of RFSP (“RAT/Frequency Selection | Network slices load |
| Priority”) policies by a PCF | |
| Updating of an authorized QoS by a PCF | Observed service experience |
| Modification of BDT (“Background Data Transfer”) | Network performance |
| policies by a PCF | |
| Improvement of the selection of a path of the | Observed service experience |
| user plane by a PCF | |
| Determining an average data throughput per | Dispersion of data |
| network slice by a PCF | |
| Updating of WLAN policies by a PCF | WLAN performance |
| Modification of a session management policy by a | User data congestion |
| PCF | |
| Decision by an SMF for redundant retransmission | Redundant transmission experience |
| Prevention of DNN (“Data Network Name”) or S- | Effect of applying a mechanism for |
| NSSAI congestion by an SMF | preventing congestion in session |
| | management |
| Updating policies by a PCF in order to maintain | Quality of Service (or QoS) durability |
| the quality of a Vehicle-to-everything (V2X) | |
| vehicle communication service | |
| Decision by an AMF concerning the MICO (“Mobile | UE mobility, UE communications |
| Initiated Connection Only”) mode | |
| Updating a mobility pattern by an AMF | UE mobility |
| Decision by an AMF relating to paging | UE mobility |
| Derivation of an expected UE behavior by an AF | UE mobility, UE communications |
| Management of service area restrictions by a PCF | Abnormal behavior |
| Decision by an SMF relating to an inactivity timer | UE communications |
| Decision by an SMF relating to the release of a | UE mobility |
| UPF of a termination point N3 | |
| Modification of RFSP policies by a PCF | UE communications and Observed service |
| | experience |
| Modification of access management and/or | User data congestion and Dispersion of |
| session management policies by a PCF | data |
| Decision concerning session management by an | Observed service experience, |
| SMF based on OSE and DN analyses | performance of Data Network (or DN) |
| Delivery of statistical or predictive analyses by an | All types of analyses, user data |
| NEF (“Network Exposure Function”) to an external | congestion |
| entity | |
| Selection of a UPF by an SMF | UPF load |
| | Observed service experience |
| | DN performance |
| | UE mobility |
| | UE communications |
| Selection/modification of a network slice by an | Network slices load |
| AMF/NSSF | Dispersion |
| | UE mobility |
| . . . | . . . |

Although the present disclosure has been described with reference to one or more examples, workers skilled in the art will recognize that changes may be made in form and detail without departing from the scope of the disclosure and/or the appended claims.

1. A method for processing a request for a statistical or predictive analysis received by a first application entity of a communications network originating from a second application entity of the network, said method being performed by a device implementing the first application entity and comprising:
determining, based on at least a plurality of parameters conveyed by said request and defining the analysis requested by the second application entity, a formulation context for said request by said second application entity;
carrying out said requested statistical or predictive analysis by using an analysis model selected as a function of said determined context; and
delivering at least one result of the analysis carried out in response to said request from the second application entity.

2. The processing method as claimed in claim 1, wherein, during the determining, said formulation context is also determined based on a parameter introduced by the second application entity into a dedicated field of the request.

3. The processing method as claimed in claim 1, wherein said plurality of parameters is selected from among:
an identity of the second application entity;
a parameter representing a requested type of analysis;
at least one equipment on which said analysis is based;
a parameter representing a condition for carrying out said analysis;
an expected level of precision for said analysis;
a parameter representing a notification term of said at least one result of the analysis.

4. The processing method as claimed in claim 1, wherein said formulation context identifies a procedure that is intended to be executed by the second application entity in the network using the result provided by the first application entity.

5. The processing method as claimed in claim 1, wherein selecting the analysis model comprises selecting at least one element from among:
a statistical or predictive analysis technique to be used to carry out the analysis;
at least one feature of a dataset to be used for carrying out the analysis and/or training an analysis technique used to carry out the analysis;
configuring an analysis technique used to carry out the analysis.

6. The processing method as claimed in claim 1, comprising a preliminary step of configuring the first application entity with a list of analysis models in which each analysis model is associated with at least one formulation context for a request, with said analysis model applied during the carrying out of the analysis being an analysis model that in said list is associated with the context determined during the acquisition.

7. The processing method as claimed in claim 1, comprising learning, during which the first application entity:
establishes correlations between analysis models, formulation contexts for a request, and quality indicators of the analyses carried out based on said models in said contexts; and
associates, based on said established correlations, an analysis model optimizing said quality with at least one formulation context for a request;
with said analysis model applied during the carrying out of the analysis being selected based on the associations established during the learning.

8. The processing method as claimed in claim 1, comprising:
a preliminary step of configuring the first application entity with a list comprising at least one analysis model associated with at least one formulation context for a request;
learning, during which the first application entity:
establishes correlations between analysis models, formulation contexts for a request, and quality indicators of the statistical analyses carried out based on said models in said contexts; and
updates and/or supplements said list based on said established correlations;
with the analysis model applied during the carrying out of the analysis being an analysis model associated with the context determined during the acquisition in the list updated or completed during the learning.

9. The processing method as claimed in claim 1, wherein the first application entity and the second application entity host network functions, with said network function hosted by the first application entity being a data collection and analysis function of the network.

10. A non-transitory computer readable medium comprising a computer program stored thereon comprising instructions for implementing the processing method as claimed in claim 1 when said program is executed by a computer.

11. A device of a communications network, the device comprising:
at least one processor; and
at least one non-transitory computer readable medium comprising instructions stored thereon which when executed by the at least one processor implement a first application entity, the first application entity being configured to:
receive a request for a statistical or predictive analysis from a second application entity of the network;
determine a formulation context for said request by said second application entity at least based on a plurality of parameters defining the analysis requested by the second application entity and conveyed in the analysis request;
carry out said analysis by using an analysis model that is selected as a function of said formulation context; and
deliver at least one result of the analysis carried out in response to said request from the second application entity.

12. The device as claimed in claim 11, wherein said first application entity determines said formulation context based on a parameter introduced by the second application entity into a dedicated field of the request.

13. A system in a communications network comprising:
at least one device as claimed in claim 11; and
at least one second device implementing the second application entity, wherein the at least one second device comprises:
at least one second processor; and
at least one second non-transitory computer readable medium comprising instructions stored thereon which when executed by the at least one second processor configure the at least one second device to:
send said at least one first application entity of the network the request for a statistical or predictive analysis comprising the plurality of parameters defining the analysis requested by the second application entity and introduced into the dedicated field of the request, with a parameter indicating the formulation context for said request; and
receive, from said at least one first application entity in response to said request, the at least one result of the requested analysis carried out by said at least one first application entity by using the analysis model that is selected as a function of the formulation context for the request determined by said at least one first application entity based on said plurality of parameters defining the analysis requested by the second application entity and on said parameter introduced into said dedicated field of the request.
